(19) United States
(12) Patent Application Publication
(10) Pub. No.: US 2009/0273887 A1
(43) Pub. Date: Nov. 5, 2009

(54) Memory Device, Electronic Device, and Method for Producing a Memory Device

(76) Inventor: Klaus Elian, Altglofsheim (DE)

Correspondence Address: SLATER & MATSIL, L.L.P., 17950 PRESTON ROAD, SUITE 1000, DALLAS, TX, 75252, US

(21) Appl. No.: 12/112,901

(22) Filed: Apr. 30, 2008

(51) Int. Cl. H01G 9/012

(52) U.S. Cl. 361/524; 29/25.03

(57) ABSTRACT

A memory device has a plurality of first electrodes, a plurality of second electrodes separated from the first electrodes, and an electrolyte located between the first electrodes and the second electrodes. The first electrodes and the second electrodes include lithium.

### BACKGROUND

In modern electronic devices it is often necessary to provide data storage.

### BRIEF DESCRIPTION OF THE DRAWINGS

FIG. 1 depicts a schematic representation of an embodiment of a memory device;

FIG. 2 depicts a schematic representation of another embodiment of a memory device; and

FIG. 3 depicts a flow chart of a method for producing a memory device

### DETAILED DESCRIPTION OF ILLUSTRATIVE EMBODIMENTS

In the following a possible embodiment for a memory device is described.

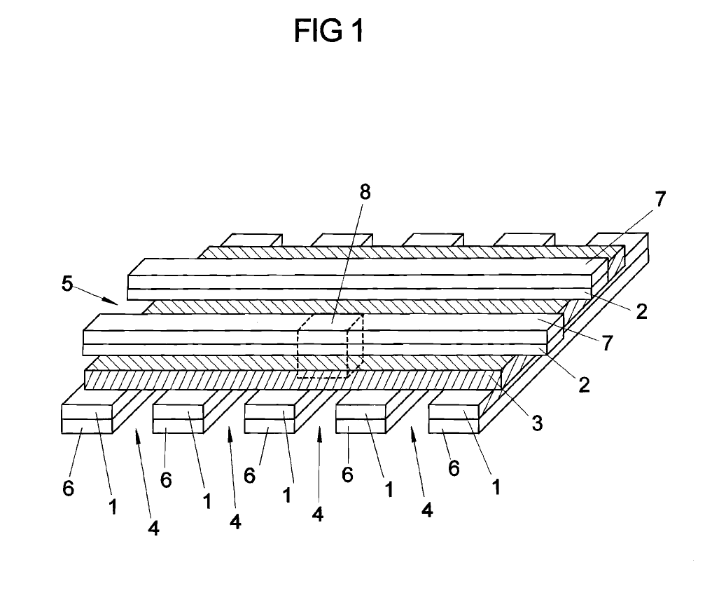

FIG. 1 depicts a cut-out of a memory device having a plurality of first electrodes 1, a plurality of second electrodes 2 which are separated from the first electrodes 1, and an electrolyte 3 located between the first electrodes 1 on the one hand and the second electrodes 2 on the other hand. The first electrodes 1 and the second electrodes 2 comprise lithium in each case. Lithium ions are a possible form of lithium being present in the first and second electrodes 1, 2.

The memory device may be, e.g., a memory module, a memory chip, or a part of a chip. Other forms are also possible. The memory device may serve as data storage.

The first electrodes 1 can be made from a metal oxide of lithium. For example, the metal oxide can be at least one of LiCoO₂, LiNiₓCo_{y}O₂ with x=0 to 1 and y=0 to 1 and the sum of x and y being 1, and LiMn₂O₄. Other lithium metal oxides are also possible. In any case, the metal oxide may be regarded as base material whereas lithium is associated to this base material or is part of a complex of the base material and lithium.

The second electrodes 2 can comprise an organic lithium compound. The organic lithium compound can be, e.g., at least one of a lithium carbon compound having the general formula LiC₆, a carbon-sulfur compound, a sulfur containing organic compound, and a conductive lithium-containing organic polymer. In this case, the carbon component, the carbon-sulfur compound, the sulfur containing organic compound, and the organic polymer can be regarded as base material. Lithium may be intercalated into this base material. For example, a lithium graphite intercalation compound is suited as material for the second electrodes 2. The first electrodes 1 can be seen as positive electrodes (anodes) and the second electrodes 2 can be seen as negative electrodes (cathodes).

The first electrodes 1 are arranged in an essentially parallel way to each other. Further, the second electrodes 2 are also arranged in an essentially parallel way to each other. Both the first electrodes 1 and the second electrodes 2 are of the same shape in each case and are formed in a bar-like (or stripe-like), longitudinal manner. However, it is possible that the first electrodes 1 differ in size and/or shape from the second electrodes 2. Further, it is possible that the first electrodes 1 are themselves with respect to each other not identical regarding size and/or shape. The same is applicable for the second electrodes 2.

In the embodiment of FIG. 1, the first electrodes 1 extend essentially perpendicular to the second electrodes 2 with respect to their longitudinal side. Thus, a checkered pattern is formed by the first electrodes 1 and the second electrodes 2.

Between the first electrodes 1, in a plane with and parallel to them, in a space 4, an insulating material is provided to insulate the single first electrodes 1 from each other. For better graphical representation, this insulating material is omitted in FIG. 1. Further, between the second electrodes 2, in a plane with and parallel to them, in a space 5, an insulating material is provided to insulate the single second electrodes 2 from each other. For better graphical representation, this insulating material is also omitted in FIG. 1.

The insulating material between the first electrodes 1 and between the second electrodes 2 can be the same or a different material. For example, a low-K dielectric can be used as insulating material. A low-K dielectric is a material having a small dielectric constant being equal to or less than that of silicon dioxide (SiO₂). Thus, silicon dioxide and many organic insulators are examples of low-K dielectrics.

As already mentioned, between the plurality of first electrodes 1 on the one hand and the plurality of second electrodes 2 on the other hand, the electrolyte 3 is located. It is to be noted that the electrolyte 3 is neither present in the space 4 between individual first electrodes 1 nor in the space 5 between individual second electrodes 2. The electrolyte may comprise a polymeric electrolyte carrier and an ionic conductor. Both polymeric electrolyte carrier and ionic conductor form a gel-like or solid electrolyte 3. Suited polymeric electrolyte carriers are, e.g., polyethylene oxide, polyacrylonitrile, polyphenylene plastic, polyvinylidene difluoride hexafluoropropylene copolymer, polyaniline and a polymer with molecularly bound ions. Combinations of these and other carriers are possible.

Non-limiting examples of ionic conductors that may be used within other embodiments are LiCF₃SO₃, Li_{1,3}Al_{0,3}Ti_{1,7}(PO₄)₃, LiTaO₃, LiTi₂(PO₄)₃.Li₃PO₄, LiCl, LiBr, LiJ.

On the bottom of the first electrodes 1, a first layer of metal 6 is provided. This first layer of metal 6 may be made from aluminum. Other metals are also possible. It represents a lead and may serve, e.g., as a current collector or as a word line or as a bit line.

On the top of the second electrodes 2, a second layer of metal 7 is provided. This second layer of metal 7 may be made from copper. Other metals are also possible. It is arranged and provided to work as a lead and may serve, e.g., as a current collector or as a word line or as a bit line.

Due to the essentially perpendicular arrangement of the first electrodes 1 with respect to the second electrodes 2, cross-over points between the first and second electrodes 1, 2 are generated. The term “cross-over point” implies a cross-over of a projection of a first electrode 1 into the plane of the second electrodes 2 and a second electrode 2, or a equivalently projected second electrode 2 and a first electrode 1.

Thus, since the first electrodes 1 are separated from the second electrodes 2, a physical intersection between the first electrodes 1 and the second electrodes 2 does not occur. However, when looking directly from the top or directly from the bottom towards the memory device, there are points within the memory device at which the first electrodes apparently occupy the same space as the second electrodes, i.e., there are apparent intersections. These apparent intersections can be observed since spatial information of the electrodes is omitted in one dimension by this kind of observation.

These points or apparent intersections are cross-over points. One of these cross-over points 8 is depicted in FIG. 1 by dashed lines as a representative for all cross-over points. The cross-over point 8 defines a cell or memory cell of the memory device and comprises parts of a first electrode 1, of a second electrode 2, of the electrolyte 3, of the first layer of metal 6 and of the second layer of metal 7. Optionally, it further comprises parts of an insulating material in the spaces 4, 5.

To address a single cell of the memory device, a process already known in the context of magneto resistive random access memory (MRAM) may be used: a state to be written into a cell or to be read from a cell is written into or read from that cell at which a bit line and a word line cross each other.

In FIG. 1, the first layer of metal 6 which is arranged on the bottom of the third electrode from the left of the first electrodes 1 serves as bit line for the marked cell at the cross-over point 8. Further, the second layer of metal 7 on top of the front second electrode 2 serves as word line for the marked cell. Thus, by using this bit line and this word line, the marked cell can be addressed.

Reading the status from the cell may influence the charge state of the cell, although this influence is generally much smaller as compared to classic dynamic random access memory (DRAM). However, in an embodiment the status of the cell is rewritten into the cell after reading its status. In another embodiment, the status is not rewritten into the cell after reading its status.

To address or control the cells of the memory device, a control device may be used in an embodiment. This control device is not shown in FIG. 1. For example, a transistor may be used as a control device. Each cell may be controlled by a single control device. It may also be possible to control more than one cell by one control device or to use more than one control device to control one cell.

The status of any cell of the memory device referred to above is to be understood as logical status and may be “0” or “1”. The logical status corresponds to the electrochemical status of the cell. If the cell is electrochemically charged or loaded, its logical status is “1”. If the cell is electrochemically discharged or unloaded, its logical status is “0”. A cell is to be understood as charged if its charge is above a predeterminable value. A cell is to be understood as discharged if its charge is below the predeterminable value.

A cell may be charged or discharged in a way explained in the following. Assuming by way of example the first electrodes 1 being positive electrodes and comprising a lithium metal oxide LiMO, and the second electrodes 2 being negative electrodes and comprising a lithium carbon compound LiC, charge and discharge reactions would be as depicted below.

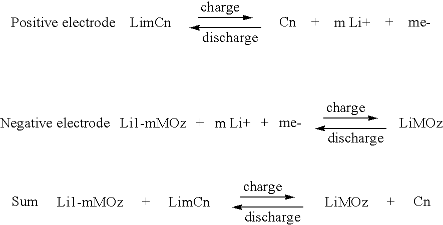

During charging the cell, electrodes flow from the positive electrode to the negative electrode. During discharging of the cell, electrodes flow in the opposite direction, i.e., from the negative electrode to the positive electrode. Lithium ions are transported from the positive electrode by means of an electrolyte to the negative electrode while charging the cell and the opposite way while discharging the cell.

That is, information is stored in the form of different oxidation states of lithium directly at the electrode surfaces. At these surfaces lithium is immobilized in the form of a lithium metal oxide, an organic lithium polymer, a lithium carbon compound or the like.

The electrolyte 3 enables the flow of lithium ions from one electrode to the other, but does itself not store charge or information.

Since a self discharge of any cell of the memory device can be almost negligible, the information stored in the cells of the memory device may be considered being non-volatile. The electrochemical state of each cell (and thus its logical state) can be maintained even if the memory device is disconnected from a power supply.

Since reading and writing processes take place at the surfaces of the first electrodes 1 and of the second electrodes 2 only, but not in bulk material between the electrodes (i.e., not in the electrolyte 3), very short read and write cycles and thus a high speed in reading and writing can be achieved. Further, due to the fact that read and write processes are chemical redox reactions, a comparative small amount of energy is needed and a comparative small amount of heat is produced.

It is possible to provide a substrate onto which the memory device is located. Such a substrate may be a silicon wafer, a silicon-on-insulator (SOI) wafer, a glass plate, a flexible foil or any other material which seems to be suited as a substrate. The substrate may be located below the first layer of metal 6 or on top of the second layer of metal 7 and should be applied in such a way that an electrical contact to every first or second layer of metal 6, 7 is still possible.

Considering an energy density of 300 Wh/l=300 VAh/l=300*3600 VAs/l=1 080 000 VAs/l and a nominal voltage of 3.6 V per cell, a charge density of 300 000 As/l per cell can be calculated. This charge density can be converted into a charge carrier particle concentration by using Faraday's law: F=e*Nₐ=10⁵ As/mol with e=1 in case of lithium. Thus, 300 000 As/l equal 3 mol/l. 3 mol*6*10²³ particles amount to 1.8*10²⁴ charge carrier particles per liter. Consequently, 1 femtolitre (a 1-μm³ cube) contains 1.8*10⁹ charge carrier particles.

In case of a 30-nm node, cube-like cells having an edge length of 30 nm would be realized, having a volume of 2.7*10⁻⁵ μm³. In a cube like this, 1.8*10⁹*2.7*10⁻⁵=48 600 charge carrier particles would be present. Thus, very fine structures are achievable, since even in very small volumes a sufficiently high number of charge carrier particles are present.

A memory device or array of cells as described above can be used in an electronic device. An electronic device can comprise more than one of such memory devices. The memory device can be formed in a removable or in a non-removable manner, thus enabling many designs and applications. Non-limiting examples of an electronic device are a personal computer, a server, a mobile phone, an mp3 player, a personal digital assistant, and the like.

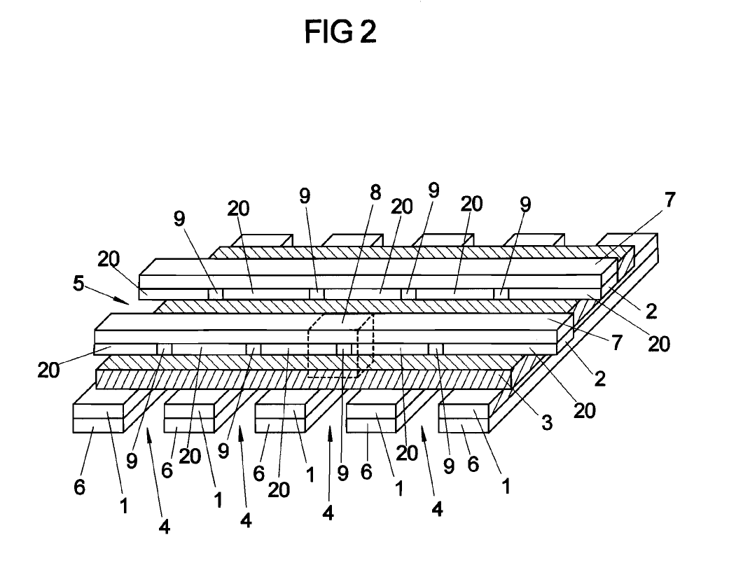

FIG. 2 depicts a cut-out from another embodiment of a memory device which is similar to the embodiment of FIG. 1. Therefore, reference is made to the preceding explanations. Further, the same numeral references as in FIG. 1 are assigned to identical elements of the memory device of FIG. 2.

In this embodiment, the second electrodes 2 are divided by an electrically insulating material 9 into a plurality of distinct sub-electrodes 20. Thus, a stripe or bar of a plurality of sub-electrodes 20 which are separated from each other in an electrically non-conducting manner by the electrically insulating material 9 is formed. However, other electrode forms are also possible. The sub-electrodes 20 can be contacted by a lead or layer of metal 7, e.g., in the same way as in case of electrodes which are not divided into sub-electrodes.

In this embodiment, the electrically insulating material 9 is provided at a site of the second electrodes 2 at which the second electrodes 2 are not directly located over the first electrodes 1. Thus, each sub-electrode 20 of one of the second electrodes 2 is assigned to a different first electrode 1. A different location of the electrically insulating material 9 is possible.

In this embodiment, only the second electrodes 2 are divided into sub-electrodes 20. However, it is possible that the first electrodes 1 are also separated into distinct sub-electrodes. Thus, a pattern of a plurality of cross-over points 8, each comprising a single sub-electrode 20 of one of the second electrodes 2 and a single sub-electrode of one of the first electrodes 1 is possible.

It is further possible that only a single or some of the first electrodes 1 and/or the second electrodes 2 are divided into sub-electrodes.

The electrical insulating material 9 may be the same like the insulating material in the spaces 4, 5 or may be different thereof.

Dividing the first electrodes 1 and/or second electrodes 2 into sub-electrodes inhibits charge diffusion processes within the electrode surfaces from a first sub-electrode to a second sub-electrode of the same electrode.

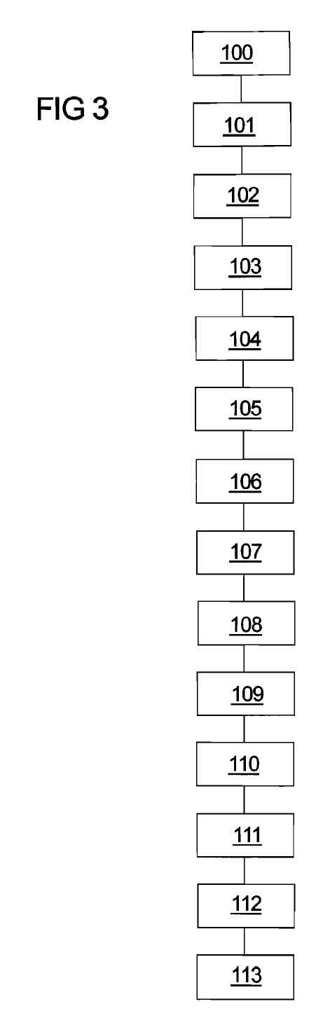

FIG. 3 shows a flow-chart of a possible method to construct a memory device, e.g. a memory device as described above. This method comprises the following subsequent steps: providing a substrate (100); applying a first metal onto the surface of the substrate (101); applying a first electrode material onto the surface of the first metal, the first electrode material comprising lithium (102); first photolithography process to structure a first electrode and leads of the first metal (103); first etching to structure a first electrode and leads of the first metal (104); applying a first dielectric onto the structured surface formed so far (105); removing excessive material so that the layer of the first electrode material forms at least a part of the surface formed so far (106); applying an electrolyte onto the surface formed so far (107); applying a second dielectric onto the surface formed so far (108); second photolithography process to structure the second dielectric (109); second etching to structure the second dielectric (110); applying a second electrode material onto the structured surface formed so far, the second electrode material comprising lithium (111); applying a second metal onto the structured surface formed so far (112); and removing excessive material so that the second metal forms at least a part of the surface of the memory device (113).

A silicon wafer may be used as substrate. The silicon may be oxidized, e.g., by a thermal oxidation, to produce an insulating silicon dioxide top surface on the substrate. Aluminum may be used as first metal; it can be applied onto the surface by large-area sputtering.

Lithium and cobalt may be used as first electrode material; both metals can be applied onto the surface by large-area sputtering. Initially it can be worked under an inert gas atmosphere like an argon atmosphere. Subsequently it can be worked under an atmosphere containing a certain amount of oxygen to yield formation of lithium cobalt oxide (LiCoO₂). Such an oxide layer prevents the layer of aluminum or other first metal from oxidation when working under oxygen atmosphere in the next steps.

The first lithography can be done as a positive process. Silicon dioxide may be used as a dielectric; it can be applied by sputtering. Excessive material can be removed by chemical-mechanical polishing.

The electrolyte may be applied by spin coating a polymer electrolyte carrier and a salt solution providing charge carrier ions. To finally form the electrolyte, a thermal drying may be done.

The second dielectric may be the same as the first dielectric. Alternatively, it may be a different substance.

The second electrode material may be applied by spin coating in case of a lithium-containing organic polymer solution or by sputtering in case of a lithium graphite intercalation compound or by any other appropriate method in case of these or other substances. A thermal drying may be done to finally form the second electrode material.

The second metal may be copper; it can be applied by sputtering.

All of the afore-mentioned specifications of materials, methods, layouts, arrangements and so on are to be understood as non-limiting examples. Other materials, methods, layouts, arrangements and so on may be suited as well.

What is claimed is:

1. A memory device, comprising:
a plurality of first electrodes;
a plurality of second electrodes spatially separated from the first electrodes; and
an electrolyte located between the first electrodes and the second electrodes, wherein the first electrodes and the second electrodes comprise lithium.

2. The memory device according to claim 1, wherein a longitudinal side of the first electrodes extends essentially perpendicular with respect to a longitudinal side of the second electrodes.

3. The memory device according to claim 1, wherein at least one of the first electrodes and/or of the second electrodes is divided by an electrically insulating material into a plurality of distinct sub-electrodes, the electrically insulating material essentially inhibiting a direct electrical connection between the sub-electrodes.

4. The memory device according to claim 1, wherein a cross-over point between any of the first electrodes and any of the second electrodes defines a memory cell.

5. The memory device according to claim 4, further comprising a plurality of leads, the memory cell being electrically connected to at least two of the leads.

6. The memory device according to claim 4, wherein information is stored in the memory cell in an electrochemical manner.

7. The memory device according to claim 4, wherein information is stored in the memory cell in a non-volatile manner.

8. The memory device according to claim 4, further comprising a control device for controlling the memory cell.

9. The memory device according to claim 1, wherein the first electrodes, the second electrodes and/or the electrolyte comprise lithium as lithium ions.

10. The memory device according to claim 9, wherein the lithium ions are, with respect to a base material, at least one of intercalated, associated or part of a complex.

11. The memory device according to claim 1, wherein the first electrodes comprise a metal oxide of lithium.

12. The memory device according to claim 11, wherein the metal oxide is at least one of LiCoO₂, LiMn₂O₄, or LiNiₓCo_{y}O₂ with x=0 to 1 and y=0 to 1, with the further constraint that the sum of x and y is 1.

13. The memory device according to claim 1, wherein the second electrodes comprise an organic lithium compound.

14. The memory device according to claim 13, wherein the organic lithium compound is at least one of a lithium carbon compound having a general formula LiC₆, a carbon-sulfur compound, a sulfur containing organic compound, or a conductive lithium-containing organic polymer.

15. The memory device according to claim 1, wherein the electrolyte comprises a polymeric electrolyte carrier and an ionic conductor.

16. The memory device according to claim 15, wherein the polymeric electrolyte carrier comprises at least one selected from the group consisting of polyethylene oxide, polyacrylonitrile, polyphenylene plastic, polyvinylidene difluoride hexafluoropropylene copolymer, polyaniline and a polymer with molecularly bound ions.

17. The memory device according to claim 15, wherein the ionic conductor comprises at least one material selected from the group consisting of LiCF₃SO₃, Li_{1,3}Al_{0,3}Ti_{1,7}(PO₄)₃, LiTaO₃, LiTi₂(PO₄)₃.Li₃PO₄, LiCl, LiBr, and LiJ.

18. The memory device according to claim 1, wherein the first and/or the second electrodes comprise a current collector.

19. The memory device according to claim 1, wherein a space between individual electrodes of the first electrodes and/or a space between individual electrodes of the second electrodes comprise an insulating material.

20. An electronic device, comprising at least one memory device according to claim 1.

21. The electronic device according to claim 20, wherein the memory device is either removable or non-removable with respect to the electronic device.

22. A method for producing a memory device, the method comprising:
applying a first metal onto a surface of a substrate;
applying a first electrode material onto a surface of the first metal, the first electrode material comprising lithium;
photolithographically structuring a first electrode and leads of the first metal;
applying a first dielectric onto the substrate over the first electrode and leads;
applying an electrolyte onto the substrate over the first dielectric and the first electrode;
applying a second dielectric onto the substrate over the electrolyte;
photolithographically structuring the second dielectric;
applying a second electrode material onto the substrate over the structured second dielectric, the second electrode material comprising lithium; and
applying a second metal onto the substrate over the second electrode material.

23. The method according to claim 22, wherein applying the first electrode material is initially carried out under an inert gas atmosphere and subsequently under an atmosphere comprising oxygen.

24. The method according to claim 22, further comprising a first chemical mechanical polishing step after applying the first dielectric and performing a second chemical mechanical polishing step after applying the second dielectric.

25. The method according to claim 22, wherein applying the first metal, the first electrode material, the first dielectric, the electrolyte, the second dielectric, the second electrode material and/or the second metal comprises sputtering and/or spin coating.
